(19) United States
(12) Patent Application Publication
(10) Pub. No.: US 2025/0356334 A1
(43) Pub. Date: Nov. 20, 2025

(54) Technologies for Initiating Payment Processing

(71) Applicant: The PNC Financial Services Group, Inc., Pittsburgh, PA (US)

(72) Inventors: Kyle Joseph Jurick, Garrett, IN (US); Chandra Sekhar Sombhotla, Tampa, FL (US)

(21) Appl. No.: 19/199,611

(22) Filed: May 6, 2025

Related U.S. Application Data
(60) Provisional application No. 63/647,658, filed on May 15, 2024.

(51) Int. Cl. G06Q 20/22; G06Q 20/20; G06Q 20/40

(52) U.S. Cl. CPC G06Q 20/227; G06Q 20/20; G06Q 20/4014

(57) ABSTRACT

Technologies for initiating payment processing include a compute device. The compute device includes circuitry configured to obtain, at a merchant location, a notification transmitted from a merchant point of sale device, to facilitate a financial transaction. The notification may be indicative of a financial transaction that was initiated between the merchant point of sale device that is at the merchant location and a remote gateway compute device that is not at the merchant location. The circuitry may also be configured to send, to the remote gateway compute device, payor identification data that identifies the payor associated with the financial transaction. Further, the circuitry may be configured to send, to the remote gateway compute device, payment method selection data indicative of a payment method selected by the payor for the financial transaction.

This application claims the benefit of U.S. Provisional Application No. 63/647,658 filed May 15, 2024 for “Technologies for Initiating Payment Processing” and U.S. Provisional Application No. 63/656,685 filed Jun. 6, 2024 for “Technologies for Initiating Payment Processing.” Both of these applications are hereby incorporated by reference in their entireties.

### BACKGROUND

Purchases from merchants have shifted away from in-person cash transactions to transactions performed with a payment card. Indeed, for purchases performed online, cash transactions are impracticable and people have grown accustomed to using electronic forms of payment, such as by entering information from their payment card (e.g., payment card number, name, verification code, etc.) into a form on a website to complete a purchase. For in-person purchases, people have adapted to swiping, inserting, or tapping their payment card onto a point of sale device at a merchant location to transfer payment card information. Aside from the potential security risk of providing payment card information to each merchant that a person purchases from, it is inconvenient for the person to have to bring the payment card to the merchant's location or to store their payment card information in an electronic device capable of sharing the payment card information with the merchant's point of sale device.

### BRIEF DESCRIPTION OF THE DRAWINGS

The concepts described herein are illustrated by way of example and not by way of limitation in the accompanying figures. For simplicity and clarity of illustration, elements illustrated in the figures are not necessarily drawn to scale. Where considered appropriate, reference labels have been repeated among the figures to indicate corresponding or analogous elements. The detailed description particularly refers to the accompanying figures in which:

FIG. 1 is a simplified block diagram of at least one embodiment of a system for processing in-person payments with merchants;

FIG. 2 is a simplified block diagram of at least one embodiment of a compute device of the system of FIG. 1;

FIGS. 3-5 are simplified block diagrams of at least one embodiment of a method for processing in-person payments that may be executed by a payor compute device of the system of FIG. 1;

FIGS. 6-7 are simplified block diagrams of at least one embodiment of a method for processing in-person payments that may be executed by a merchant point of sale device of the system of FIG. 1;

FIGS. 8-10 are simplified block diagrams of at least one embodiment of a method for processing in-person payments that may be executed by a gateway compute device of the system of FIG. 1;

FIGS. 11-12 are diagrams of user interfaces that may be presented by a merchant point of sale device of the system of FIG. 1; and

FIGS. 13-15 are diagrams of user interfaces that may be presented by a payor compute device of the system of FIG. 1.

### DETAILED DESCRIPTION OF THE DRAWINGS

While the concepts of the present disclosure are susceptible to various modifications and alternative forms, specific embodiments thereof have been shown by way of example in the drawings and will be described herein in detail. It should be understood, however, that there is no intent to limit the concepts of the present disclosure to the particular forms disclosed, but on the contrary, the intention is to cover all modifications, equivalents, and alternatives consistent with the present disclosure and the appended claims.

References in the specification to “one embodiment,” “an embodiment,” “an illustrative embodiment,” etc., indicate that the embodiment described may include a particular feature, structure, or characteristic, but every embodiment may or may not necessarily include that particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described. Additionally, it should be appreciated that items included in a list in the form of “at least one A, B, and C” can mean (A); (B); (C); (A and B); (A and C); (B and C); or (A, B, and C). Similarly, items listed in the form of “at least one of A, B, or C” can mean (A); (B); (C); (A and B); (A and C); (B and C); or (A, B, and C).

The disclosed embodiments may be implemented, in some cases, in hardware, firmware, software, or any combination thereof. The disclosed embodiments may also be implemented as instructions carried by or stored on a transitory or non-transitory machine-readable (e.g., computer-readable) storage medium, which may be read and executed by one or more processors. A machine-readable storage medium may be embodied as any storage device, mechanism, or other physical structure for storing or transmitting information in a form readable by a machine (e.g., a volatile or non-volatile memory, a media disc, or other media device).

In the drawings, some structural or method features may be shown in specific arrangements and/or orderings. However, it should be appreciated that such specific arrangements and/or orderings may not be required. Rather, in some embodiments, such features may be arranged in a different manner and/or order than shown in the illustrative figures. Additionally, the inclusion of a structural or method feature in a particular figure is not meant to imply that such feature is required in all embodiments and, in some embodiments, may not be included or may be combined with other features.

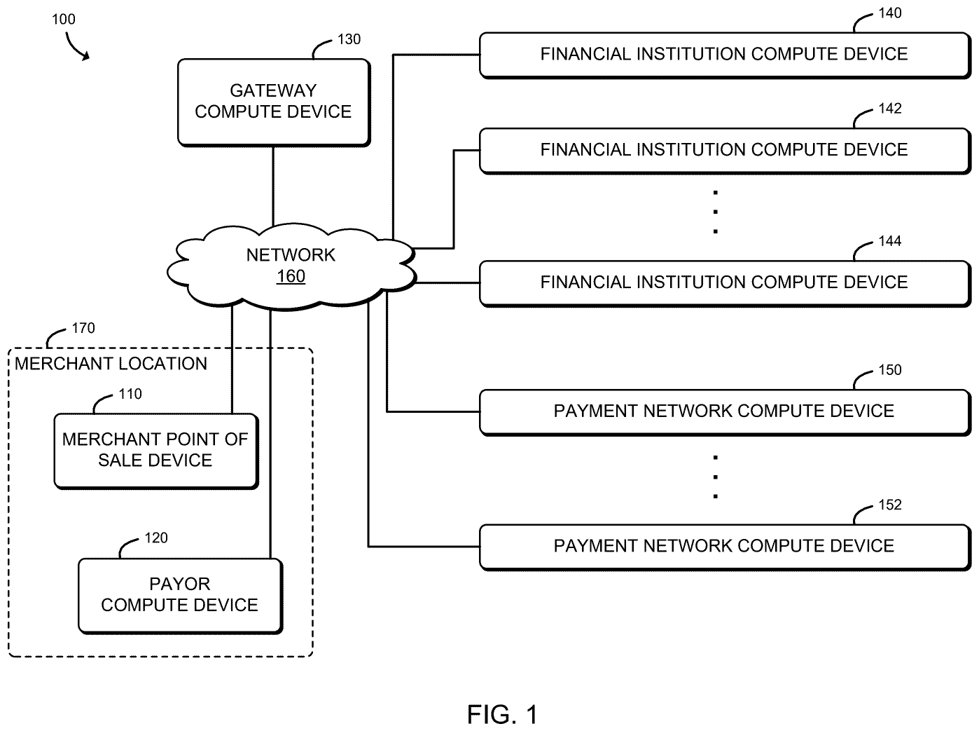

Referring now to FIG. 1, a system 100 for processing in-person payments includes, in the illustrative embodiment, a merchant point of sale device 110 (e.g., a device used to process transactions by retail customers) at a merchant location 170 (e.g., a store). As shown, the illustrative embodiment of the system 100 includes a payor compute device 120, which may be embodied as a smart phone, a tablet, or similar compute device carried by a person (e.g., customer), at the merchant location 170. Remote from (e.g., not located at) the merchant location 170 is a gateway compute device 130, which, as described in more detail herein, communicates with the merchant point of sale device 110, the payor compute device 120, one or more financial institution compute devices 140, 142, 144 (e.g., compute devices associated with financial institutions, such as banks), and one or more payment network compute devices 150, 152 (e.g., compute devices of payment networks, such as payment card processing networks (e.g., Visa, MasterCard, American Express, Discover, etc.)) to facilitate a financial transaction (e.g., purchase) by the payor from the merchant. As described in more detail herein, in operation, to conduct the financial transaction, the merchant point of sale device 110 sends a request to the gateway compute device 130 to initiate a financial transaction and obtains (e.g., from the gateway compute device 130) a transaction identifier (e.g., a set of numbers, letters, and/or other symbols) to uniquely identify the financial transaction.

The merchant point of sale device 110 then provides a notification that includes the transaction identifier through a short range wireless transmission (e.g., through near-field communication or by displaying a two-dimensional bar code (e.g., QR code) representing the notification) to the payor compute device 120. Subsequently, the payor compute device 120 continues the financial transaction with the gateway compute device 130 by verifying the identity of the payor and selecting one of a set of payment methods (e.g., payment cards) available for use by the payor to complete the purchase. In the illustrative embodiment, those payment methods are registered with the financial institutions with which the payor is a customer (e.g., has one or more corresponding accounts with) and the gateway compute device 130 queries the corresponding financial institution compute devices 140, 142, 144 to determine what the available payment methods are, rather than requiring the payor to individually register those payment methods (e.g., payment cards) in the payor compute device 120 or with the gateway compute device 130. The gateway compute device 130, using the selected payment method (e.g., credit card), communicates with the corresponding compute devices (e.g., payment network compute devices 150, 152) to carry out the remainder of the financial transaction. As such, and unlike conventional systems, the payor compute device 120 does not provide any information regarding the payor's payment card(s) to the merchant point of sale device 110 during the transaction, nor is the customer (e.g., payor) required to store their payment card information in the payor compute device 120.

While relatively few compute devices 110, 120, 130, 140, 142, 144, 150, 152 are shown in FIG. 1 for simplicity and clarity, it should be understood that the number of compute devices, in practice, may range in the tens, hundreds, thousands, or more. Likewise, it should be understood that the compute devices 130, 140, 142, 144, 150, 152 may be distributed differently or perform different roles than the configuration shown in FIG. 1. Further, though shown as separate compute devices 130, 140, 142, 144, 150, 152 in some embodiments, the functionality of one or more of the compute devices 130, 140, 142, 144, 150, 152 may be combined into fewer compute devices and/or distributed across more compute devices than those shown in FIG. 1.

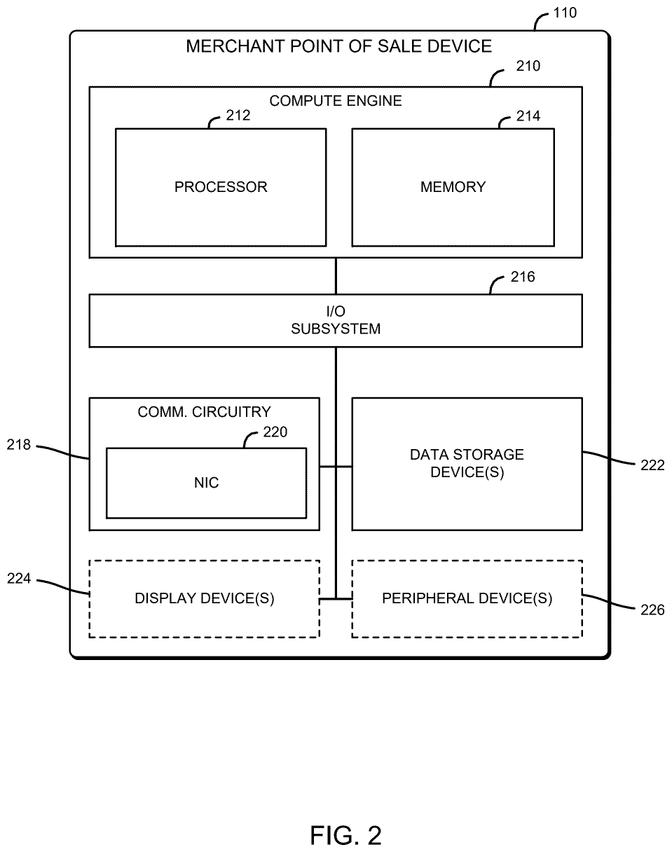

Referring now to FIG. 2, the illustrative merchant point of sale device 110 includes a compute engine 210, an input/output (I/O) subsystem 216, communication circuitry 218, and one or more data storage devices 222. In some embodiments, the merchant point of sale device 110 may include one or more display devices 224 and/or one or more peripheral devices 226 (e.g., a physical keyboard, a payment card reader, etc.). In some embodiments, one or more of the illustrative components may be incorporated in, or otherwise form a portion of, another component. The compute engine 210 may be embodied as any type of device or collection of devices capable of performing various compute functions described below. In some embodiments, the compute engine 210 may be embodied as a single device such as an integrated circuit, an embedded system, a field-programmable gate array (FPGA), a system-on-a-chip (SOC), or other integrated system or device. Additionally, in the illustrative embodiment, the compute engine 210 includes or is embodied as a processor 212 and a memory 214. The processor 212 may be embodied as any type of processor capable of performing the functions described herein. For example, the processor 212 may be embodied as a single or multi-core processor(s), a microcontroller, or other processor or processing/controlling circuit. In some embodiments, the processor 212 may be embodied as, include, or be coupled to an FPGA, an application specific integrated circuit (ASIC), reconfigurable hardware or hardware circuitry, or other specialized hardware to facilitate performance of the functions described herein.

In embodiments, the processor 212 is capable of receiving, e.g., from the memory 214 or via the I/O subsystem 216, a set of instructions which when executed by the processor 212 cause the merchant point of sale device 110 to perform one or more operations described herein. In embodiments, the processor 212 is further capable of receiving, e.g., from the memory 214 or via the I/O subsystem 216, one or more signals from external sources, e.g., from the peripheral devices 226 or via the communication circuitry 218 from an external compute device, external source, or external network. As one will appreciate, a signal may contain encoded instructions and/or information. In embodiments, once received, such a signal may first be stored, e.g., in the memory 214 or in the data storage device(s) 222, thereby allowing for a time delay in the receipt by the processor 212 before the processor 212 operates on a received signal. Likewise, the processor 212 may generate one or more output signals, which may be transmitted to an external device, e.g., an external memory or an external compute engine via the communication circuitry 218 or, e.g., to one or more display devices 224. In some embodiments, a signal may be subjected to a time shift in order to delay the signal. For example, a signal may be stored on one or more storage devices 222 to allow for a time shift prior to transmitting the signal to an external device. One will appreciate that the form of a particular signal will be determined by the particular encoding a signal is subject to at any point in its transmission (e.g., a signal stored will have a different encoding that a signal in transit, or, e.g., an analog signal will differ in form from a digital version of the signal prior to an analog-to-digital (A/D) conversion).

The main memory 214 may be embodied as any type of volatile (e.g., dynamic random access memory (DRAM), etc.) or non-volatile memory or data storage capable of performing the functions described herein. Volatile memory may be a storage medium that requires power to maintain the state of data stored by the medium. In some embodiments, all or a portion of the main memory 214 may be integrated into the processor 212. In operation, the main memory 214 may store various software and data used during operation such as transaction identifiers, applications, libraries, and drivers.

The compute engine 210 is communicatively coupled to other components of the merchant point of sale device 110 via the I/O subsystem 216, which may be embodied as circuitry and/or components to facilitate input/output operations with the compute engine 210 (e.g., with the processor 212 and the main memory 214) and other components of the merchant point of sale device 110. For example, the I/O subsystem 216 may be embodied as, or otherwise include, memory controller hubs, input/output control hubs, integrated sensor hubs, firmware devices, communication links (e.g., point-to-point links, bus links, wires, cables, light guides, printed circuit board traces, etc.), and/or other components and subsystems to facilitate the input/output operations. In some embodiments, the I/O subsystem 216 may form a portion of a system-on-a-chip (SoC) and be incorporated, along with one or more of the processor 212, the main memory 214, and other components of the merchant point of sale device 110, into the compute engine 210.

The communication circuitry 218 may be embodied as any communication circuit, device, or collection thereof, capable of enabling communications over a network between the merchant point of sale device 110 and another device (e.g., a compute device 120, 130, etc.). The communication circuitry 218 may be configured to use any one or more communication technology (e.g., wired or wireless communications) and associated protocols (e.g., Ethernet, Wi-Fi®, WiMAX, Bluetooth®, etc.) to effect such communication.

The illustrative communication circuitry 218 includes a network interface controller (NIC) 220. The NIC 220 may be embodied as one or more add-in-boards, daughter cards, network interface cards, controller chips, chipsets, or other devices that may be used by the merchant point of sale device 110 to connect with another compute device (e.g., a compute device 120, 130, etc.). In some embodiments, the NIC 220 may be embodied as part of a system-on-a-chip (SoC) that includes one or more processors, or included on a multichip package that also contains one or more processors. In some embodiments, the NIC 220 may include a local processor (not shown) and/or a local memory (not shown) that are both local to the NIC 220. Additionally or alternatively, in such embodiments, the local memory of the NIC 220 may be integrated into one or more components of the merchant point of sale device 110 at the board level, socket level, chip level, and/or other levels.

Each data storage device 222, may be embodied as any type of device configured for short-term or long-term storage of data such as, for example, memory devices and circuits, memory cards, hard disk drives, solid-state drives, or other data storage device. Each data storage device 222 may include a system partition that stores data and firmware code for the data storage device 222 and one or more operating system partitions that store data files and executables for operating systems.

Each display device 224 may be embodied as any device or circuitry (e.g., a liquid crystal display (LCD), a light emitting diode (LED) display, a cathode ray tube (CRT) display, etc.) configured to display visual information (e.g., text, graphics, etc.) to a user. In some embodiments, a display device 224 may be embodied as a touch screen (e.g., a screen incorporating resistive touchscreen sensors, capacitive touchscreen sensors, surface acoustic wave (SAW) touchscreen sensors, infrared touchscreen sensors, optical imaging touchscreen sensors, acoustic touchscreen sensors, and/or other type of touchscreen sensors) to detect selections of on-screen user interface elements or gestures from a user.

The compute devices 120, 130, 140, 142, 144, 150, 152 may have components similar to those described in FIG. 2 with reference to the merchant point of sale device 110. The description of those components of the merchant point of sale device 110 is equally applicable to the description of components of the compute devices 120, 130, 140, 142, 144, 150, 152. Further, it should be appreciated that any of the devices 110, 120, 130, 140, 142, 144, 150, 152 may include other components, sub-components, and devices commonly found in a computing device, which are not discussed above in reference to the merchant point of sale device 110 and not discussed herein for clarity of the description.

In the illustrative embodiment, the compute devices 110, 120, 130, 140, 142, 144, 150, 152, are in communication via a network 160, which may be embodied as any type of wired or wireless communication network, including global networks (e.g., the internet), wide area networks (WANs), local area networks (LANs), digital subscriber line (DSL) networks, cable networks (e.g., coaxial networks, fiber networks, etc.), cellular networks (e.g., Global System for Mobile Communications (GSM), Long Term Evolution (LTE), Worldwide Interoperability for Microwave Access (WiMAX), 3G, 4G, 5G, etc.), a radio area network (RAN), or any combination thereof.

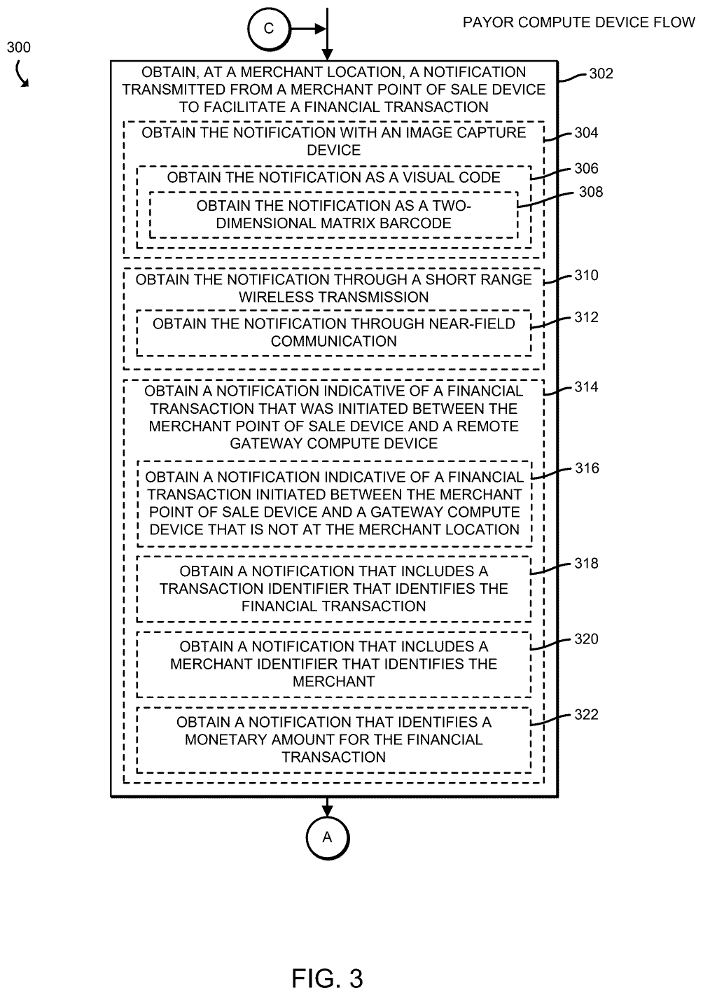

Referring now to FIG. 3, the payor compute device 120, in the illustrative embodiment, may perform a method 300 for processing an in-person payment with a merchant (e.g., at the merchant location 170). The method 300 begins with block 302 in which the payor compute device 120 obtains, at a merchant location (e.g., the merchant location 170), a notification transmitted from a merchant point of sale device (e.g., the merchant point of sale device 110) to facilitate a financial transaction. In doing so, the payor compute device 120 may obtain the notification with an image capture device (e.g., a camera), as indicated in block 304. For example, and as indicated in block 306, the payor compute device 120 may obtain the notification as a visual code. The visual code may be a two-dimensional barcode (e.g., a quick response (QR) code), as indicated in block 308. In other embodiments, the visual code may be embodied as a one dimensional bar code, or other set of symbols or shapes. In some embodiments, the payor compute device 120 may obtain the notification through a short range wireless transmission (e.g., from a low-power transmitter limited to 25-100 mW effective radiated power), as indicated in block 310. For example, and as indicated in block 312, the payor compute device 120 may obtain the notification through near-field communication.

Still referring to FIG. 3, the payor compute device 120 may obtain a notification that is indicative of a financial transaction that was initiated between the merchant point of sale device 110 and a remote gateway compute device (e.g., the gateway compute device 130), as indicated in block 314. In the illustrative embodiment, the payor compute device 120 obtains a notification indicative of a financial transaction that was initiated between the merchant point of sale device 110 and a gateway compute device 130 that is not a the merchant location 170, as indicated in block 316. The payor compute device 120 may obtain a notification that includes a transaction identifier that identifies the financial transaction that was initiated between the merchant point of sale device 110 and the remote gateway compute device 130, as indicated in block 318. In some embodiments, the payor compute device 120 may obtain a notification that includes a merchant identifier, which may be embodied as any data that identifies the merchant (e.g., associated with the merchant point of sale device 110), as indicated in block 320. Additionally or alternatively, in some embodiments, the payor compute device 120 may obtain a notification that identifies a monetary amount (e.g., dollar amount) for the financial transaction, as indicated in block 322.

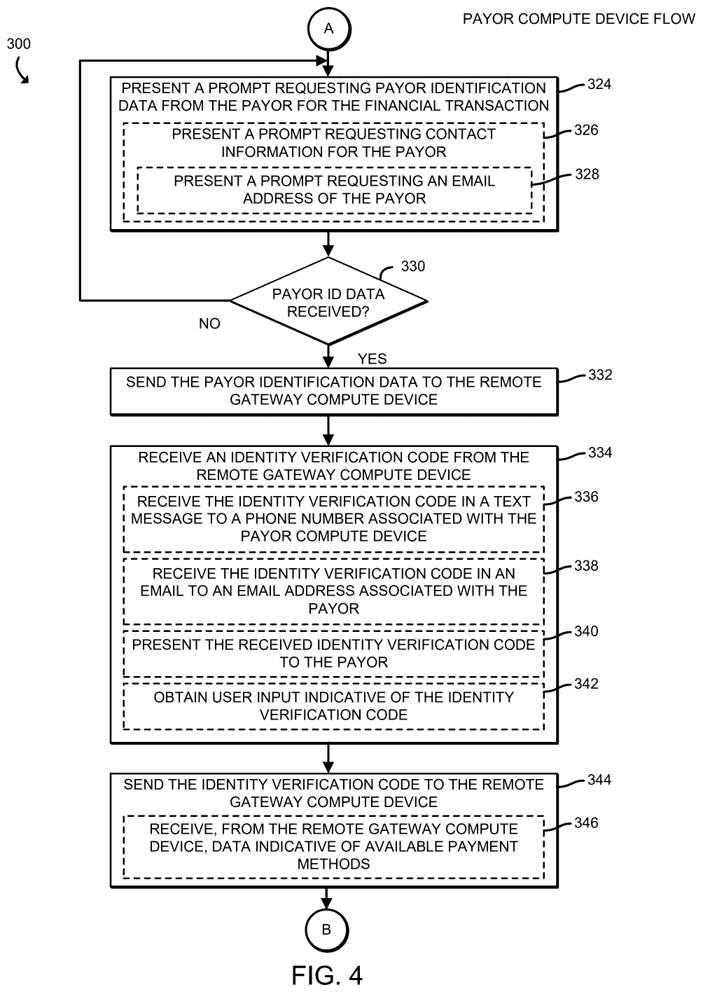

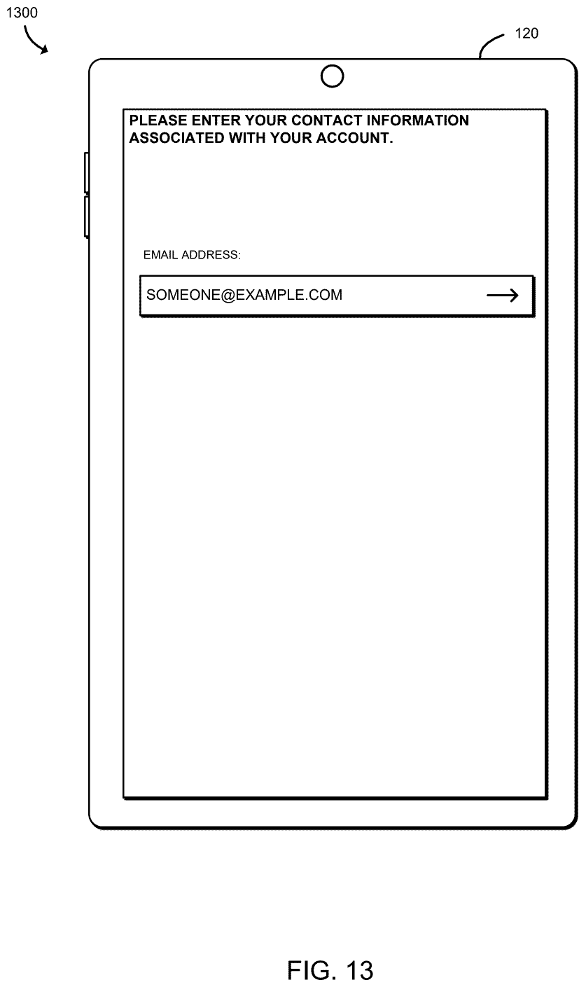

Continuing the method 300, and referring now to FIG. 4, the payor compute device 120 in the illustrative embodiment presents a prompt (e.g., a user interface) requesting payor identification data for the financial transaction, as indicated in block 324. In doing so, the payor compute device 120 may present a prompt requesting contact information for the payor, as indicated in block 326. In some embodiments, the payor compute device 120 presents a prompt requesting an email address of the payor, as indicated in block 328. An example user interface 1300 that may be presented by the payor compute device 120 to request the payor's email address is shown in FIG. 13. As indicated in block 330 and the associated loop back to block 324, the payor compute device 120 awaits receipt of the payor identification data before proceeding with additional operations of the method 300.

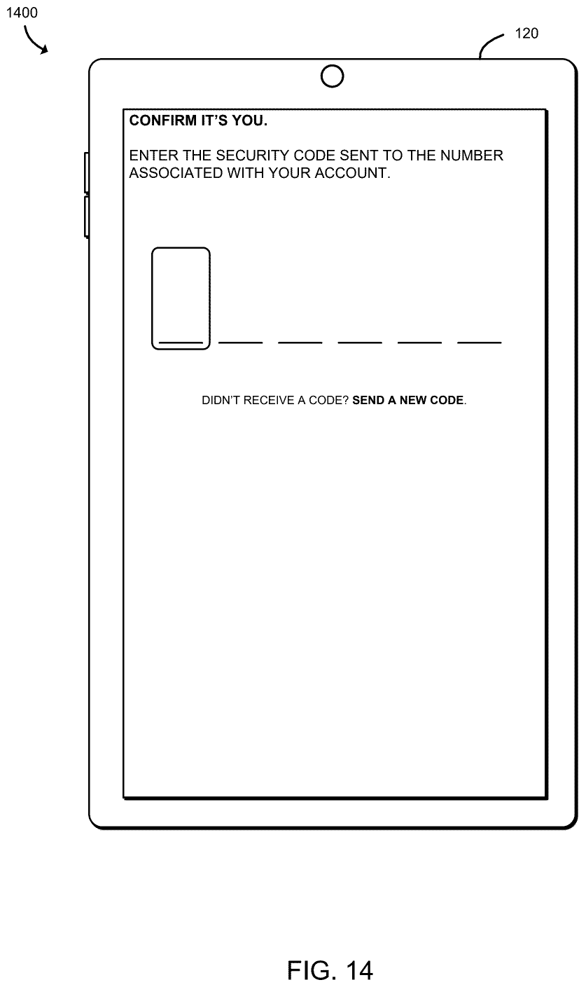

In response to a determination that the payor identification data has been received, the method 300 advances to block 332 in which the payor compute device 120 sends the payor identification data to the remote gateway compute device 130 (via the network 160), as indicated in block 332. Subsequently, and as indicated in block 334, the payor compute device 120, in the illustrative embodiment, receives an identity verification code (e.g., a sequence or numbers, letters, and/or other symbols) from the remote gateway compute device 130. As indicated in block 336, the payor compute device 120 may receive the identity verification code in a text message sent to a phone number associated with the payor compute device 120 (e.g., a phone number associated with an account of the payor that is associated with the email address provided in block 328). In other embodiments, and as indicated in block 338, the payor compute device 120 may receive the identity verification code in an email sent to an email address associated with the payor (e.g., the email address from block 328). In response to receiving the identity verification code, and as indicated in block 340, the payor compute device 120 may present the identity verification code (e.g., in a notification window) to be viewed by the payor. Additionally, in block 342, the payor compute device 120 may obtain user input indicative of the identity verification code. An example user interface 1400 that may be presented by the payor compute device 120 to allow the payor to enter the identity verification code is shown in FIG. 14. Subsequently, in block 344, the payor compute device 120 sends the identity verification code (e.g., as entered by the payor) to the remote gateway compute device 130 (e.g., through the network 160). As indicated in block 346, in the illustrative embodiment, in response to sending the identity verification code, the payor compute device 120 receives, from the remote gateway compute device 130, data indicative of available payment methods.

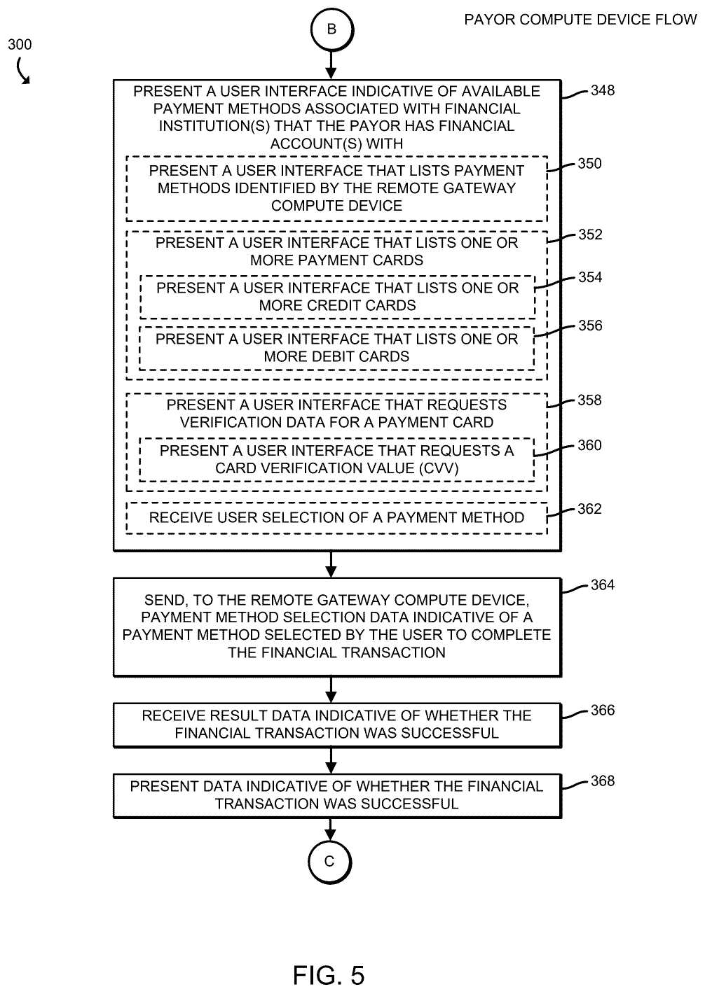

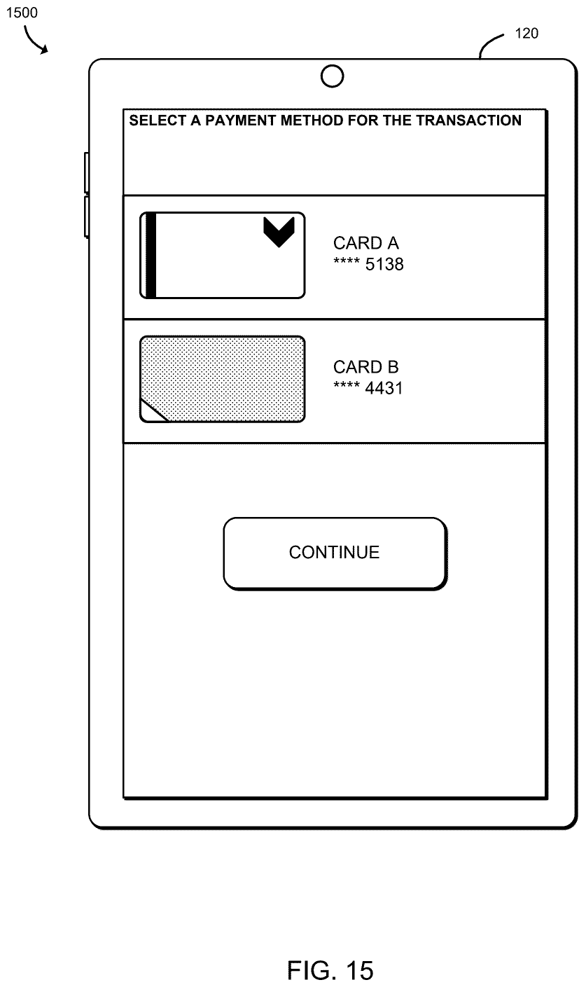

Referring now to FIG. 5, in block 348, the payor compute device 120 presents a user interface that is indicative of available payment methods associated with one or more financial institutions that the payor has one or more financial accounts with. As indicated in block 350, the payor compute device 120 may present a user interface that lists payment methods that were identified by the remote gateway compute device 130 (e.g., as represented in the data received in block 346 of FIG. 4). The payor compute device 120 may present a user interface that lists one or more payment cards, as indicated in block 352. In doing so, the payor compute device 120 may present a user interface that lists one or more credit cards as indicated in block 354 and/or one or more debit cards, as indicated in block 356. In some embodiments, the payor compute device 120 may present a user interface that requests verification data for a payment card, as indicated in block 358. For example, and as indicated in block 360, the payor compute device 120 may present a user interface that request a card verification value (CVV) for a payment card. As indicated in block 362, the payor compute device 120 may receive user selection (e.g., tap or click on) a payment method represented in the user interface. An example user interface 1500 that may be presented by the payor compute device 120 in accordance with block 348 is shown in FIG. 15.

In block 364, the payor compute device 120 may send, to the remote gateway compute device 130, payment method selection data, which may be embodied as any data that is indicative of a payment method selected (e.g., by the user) to complete the financial transaction. In block 366, the payor compute device 120, in the illustrative embodiment, receives result data (e.g., from the remote gateway compute device 130) indicative of whether the financial transaction was successful (e.g., whether the financial institution associated with the selected payment method approved the financial transaction). Correspondingly, the payor compute device 120 may present (e.g., to the payor) data indicative of whether the financial transaction was successful, as indicated in block 368.

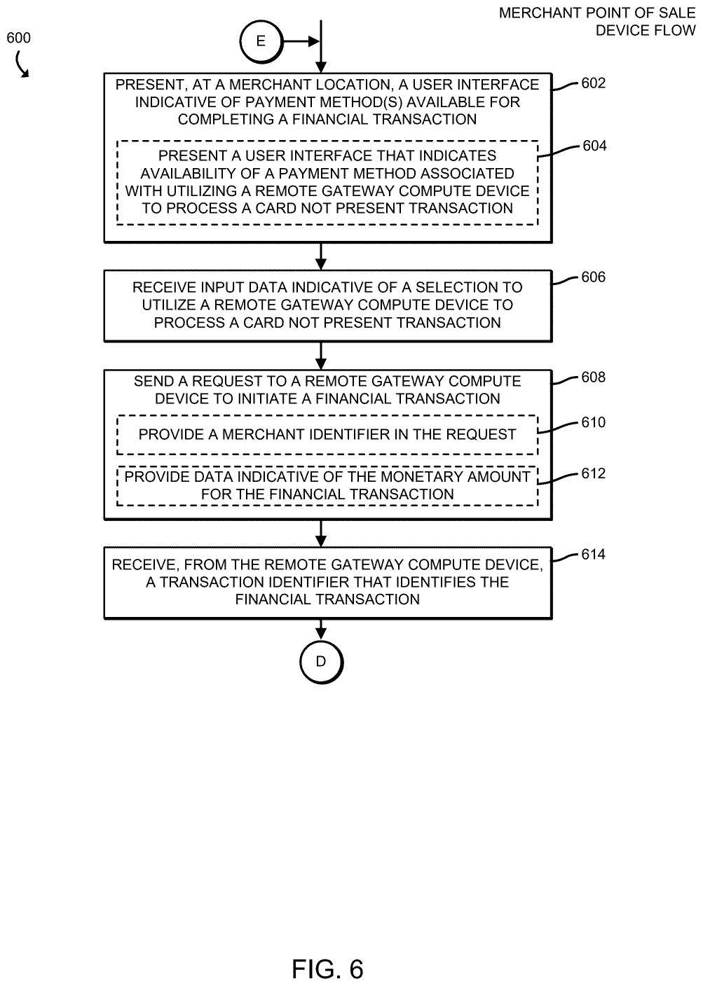

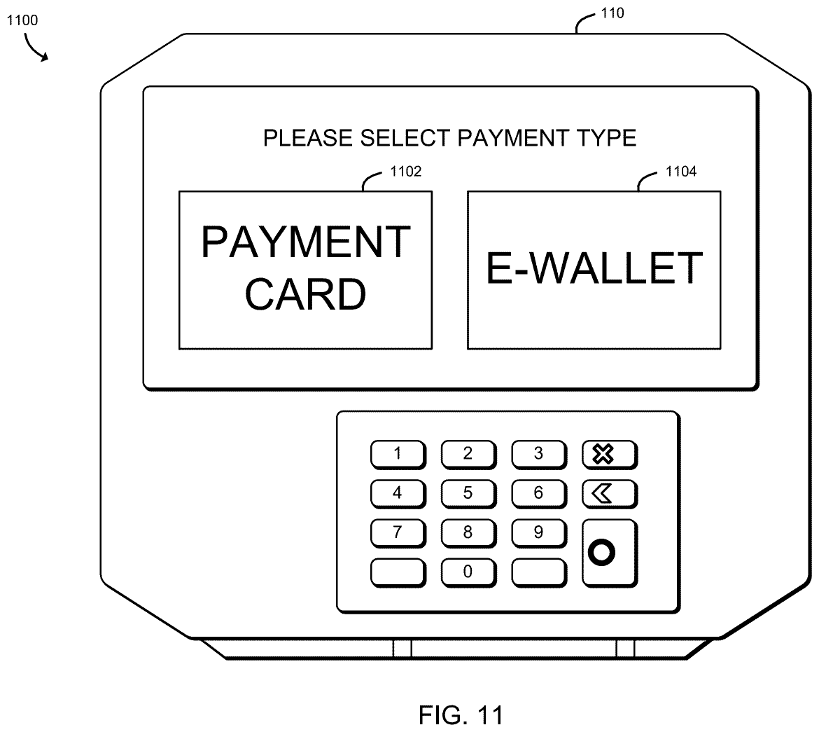

Referring now to FIG. 6, the merchant point of sale device 110, in the illustrative embodiment, may perform a method 600 for processing an in-person payment (e.g., at the merchant location 170). In doing so, in the illustrative embodiment, the merchant point of sale device 110 presents, at a merchant location 170 (e.g., the merchant point of sale device 110 is at the merchant location 170), a user interface indicative of one or more payment methods available for completing a financial transaction, as indicated in block 602. In doing so, the merchant point of sale device 110 may present a user interface that indicates the availability of a payment method associated with utilizing a remote gateway compute device (e.g., the gateway compute device 130) to process a card not present transaction, as indicated in block 604. An example user interface that the merchant point of sale device 110 may present in accordance with blocks 602 and 604 is shown in FIG. 11, in which the payor may select an icon 1102 to proceed with a card present transaction and swipe, insert, or tap their payment card on the merchant point of sale device 110 or select the icon 1104 to proceed with a card not present transaction. As shown, the icon 1104 may represent the payment method with a simpler term (e.g., “e-wallet”), a trademark associated with the payment method, an image, or the like.

Continuing the method 600, and as indicated in block 606, the merchant point of sale device 110 may receive input data indicative of a selection (e.g., by the payor) to utilize a remote gateway compute device (e.g., the gateway compute device 130) to process a card not present transaction (e.g., selection of the icon 1104). As indicated in block 608, the merchant point of sale device 110, in the illustrative embodiment, sends a request to a remote gateway compute device (e.g., the gateway compute device 130) to initiate a financial transaction (e.g., in response to receiving the selection in block 606). In doing so, the merchant point of sale device 110 may provide, in the request, a merchant identifier (e.g., a code that uniquely identifies the merchant), as indicated in block 610. The merchant point of sale device 110 may also provide, in the request, data indicative of the monetary amount for the financial transaction, as indicated in block 612. The merchant point of sale device 110, in the illustrative embodiment, receives, from the remote gateway compute device, a transaction identifier (e.g., a session identifier or other code) that identifies that financial transaction that has been initiated, as indicated in block 614.

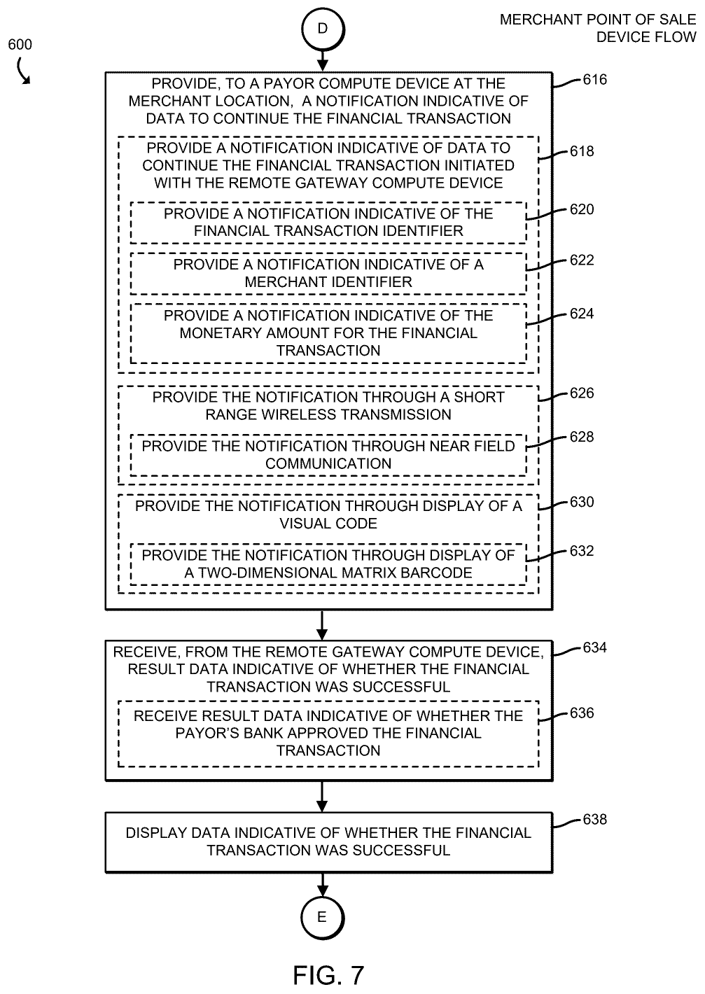

Referring now to FIG. 7, in block 616, the merchant point of sale device 110 provides, to the payor compute device 120 at the merchant location 170, a notification that is indicative of data for continuing the financial transaction. That is, and as indicated in block 618, the merchant point of sale device 110, in the illustrative embodiment, provides a notification indicative of data to continue the financial transaction that was initiated with the remote gateway compute device 130 (e.g., in block 608). As indicated in block 620, in the illustrative embodiment, the merchant point of sale device 110 provides a notification that is indicative of the financial transaction identifier (e.g., from block 614). The merchant point of sale device 110 may provide a notification that is indicative of the merchant identifier (e.g., from block 610) and/or the monetary amount for the financial transaction, as indicated in blocks 622 and 624. In some embodiments, the notification may not directly encode the data from blocks 620, 622, 624 but may refer to a data source (e.g., via a uniform resource locator or other reference) from which the payor compute device 120 may retrieve the data (e.g., with a corresponding request, such as a hyper-text transfer protocol (HTTP) request).

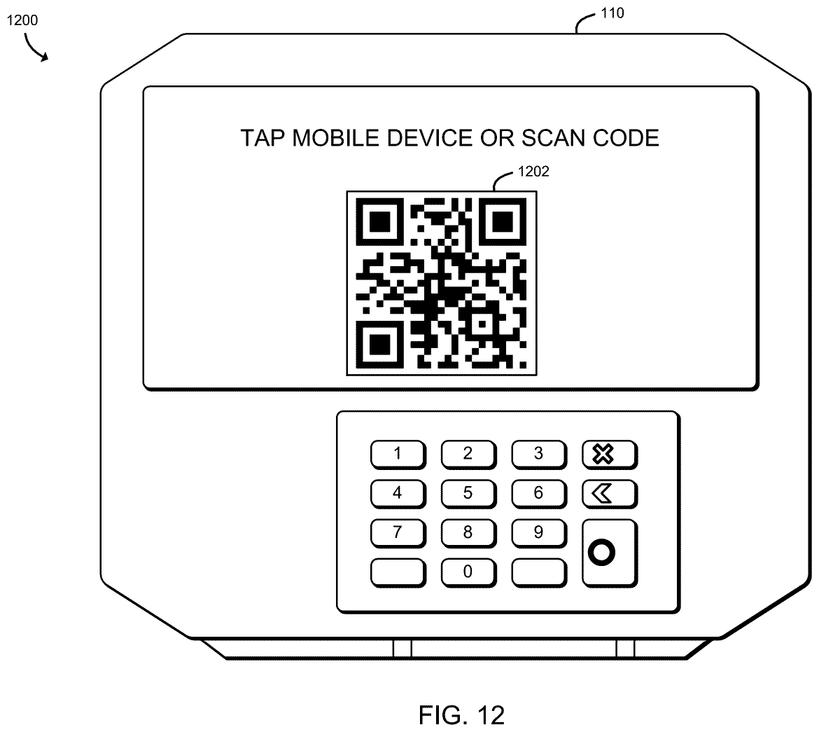

The merchant point of sale device 110 may provide the notification through a short range wireless transmission (e.g., with a low-power transmitter limited to 25-100 mW effective radiated power), as indicated in block 626. In doing so, the merchant point of sale device 110 may provide the notification through near-field communication (NFC), as indicated in block 628. Alternatively, the merchant point of sale device 110 may provide the notification through the display of a visual code, as indicated in block 630. For example, and as indicated in block 632, the merchant point of sale device 110 may provide the notification through the display of a two-dimensional matrix barcode (e.g., a QR code). An example user interface 1200 that the merchant point of sale device 110 may present, with a visual code 1202 indicative of the notification, in accordance with blocks 630 and 632, is shown in FIG. 12. Continuing the method 600, the merchant point of sale device 110, in the illustrative embodiment, receives, from the remote gateway compute device 130, result data indicative of whether the financial transaction was successful, as indicated in block 634 (e.g., after the payor compute device 120 continued the financial transaction with the remote gateway compute device 130). That is, the merchant point of sale compute device 110 may receive result data indicative of whether the payor's bank (e.g., financial institution associated with a payment card selected by the payor) approved the financial transaction, as indicated in block 636. Further, in block 638, the merchant point of sale device 110 may display data indicative of whether the financial transaction was successful (e.g., based on the data received in block 634).

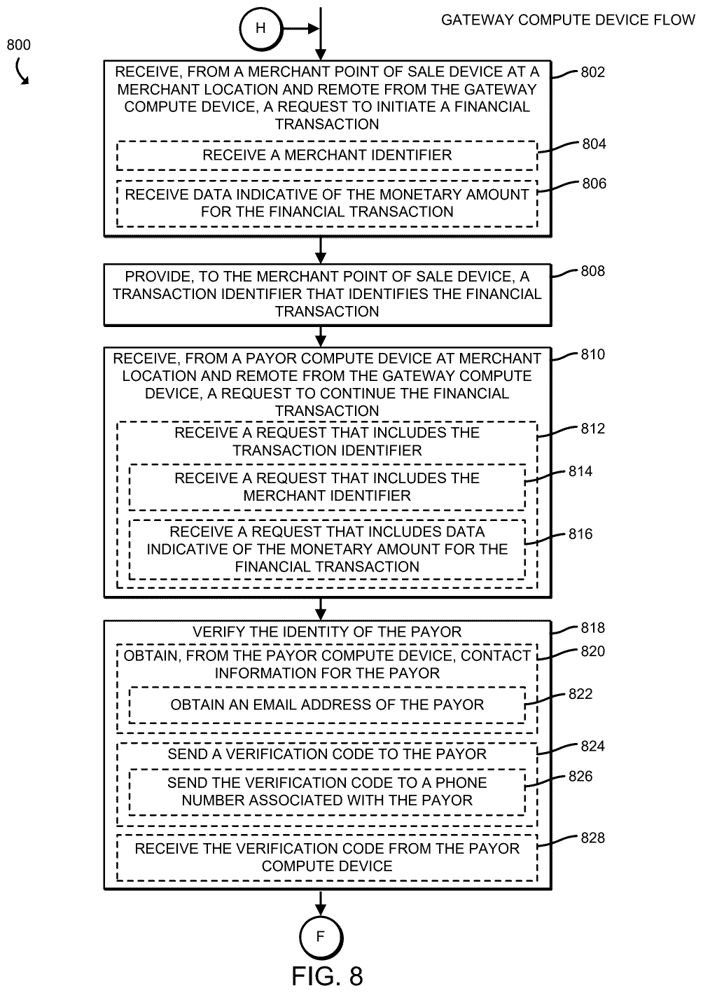

Referring now to FIG. 8, the gateway compute device 130, in the illustrative embodiment, may perform a method 800 for processing a payment (e.g., financial transaction) in accordance with the operations described relative to the methods 300, 600 performed by the payor compute device 120 and the merchant point of sale device 110, respectively. In doing so, in block 802, the gateway compute device 130 may receive, from a merchant point of sale device (e.g., the merchant point of sale device 110) at a merchant location (e.g., the merchant location 170), which is remote from the gateway compute device 130 (e.g., the gateway compute device 130 is not at the merchant location 170), a request to initiate a financial transaction. In doing so, the gateway compute device 130 may receive a merchant identifier (e.g., a code that uniquely identifies the merchant), as indicated in block 804. Further, and as indicated in block 806, the gateway compute device 130 may receive data indicative of the monetary amount (e.g., dollar amount) for the financial transaction. As indicated in block 808, the gateway compute device 130, in the illustrative embodiment, provides, to the merchant point of sale device 110 (e.g., through the network 160), a transaction identifier (e.g., a code) that identifies the financial transaction associated with the request from block 802.

Continuing the method 800 in block 810, the gateway compute device 130 receives, from a payor compute device at the merchant location (e.g., the payor compute device 120 at the merchant location 170), remote from the gateway compute device 130, a request to continue the financial transaction. The gateway compute device 130 may receive the request through the network 160. In doing so, and as indicated in block 812, the gateway compute device 130 may receive a request that includes the transaction identifier (e.g., the transaction identifier that the gateway compute device 130 provided to the merchant point of sale device 110 in block 808). In some embodiments, the gateway compute device 130 may receive a request (e.g., from the payor compute device 120) that includes the merchant identifier and/or that includes data indicative of the monetary amount (e.g., dollar amount) for the financial transaction, as indicated in blocks 814 and 816.

As indicated in block 818, the gateway compute device 130, in the illustrative embodiment, verifies the identity of the payor. In doing so, the gateway compute device 130 may obtain, from the payor compute device 120, contact information for the payor, as indicated in block 820. For example, and as indicated in block 822, in some embodiments, the gateway compute device 130 may obtain an email address of the payor (e.g., an email address associated with an account of the payor). The gateway compute device 130, in block 824, may send a verification code to the payor (e.g., to the payor compute device 120). In doing so, the gateway compute device 130 may send the verification code to a phone number associated with the payor (e.g., to a phone number stored in association with the account of the payor, which is also associated with the contact information received in block 820), as indicated in block 826. In other embodiments, the gateway compute device 130 may send the verification code to the payor through another channel, such as to the email address of the payor. In block 828, in the illustrative embodiment, the gateway compute device 130 receives the verification code back from the payor compute device 120 (e.g., after the payor views and enters the verification code that was sent in block 824).

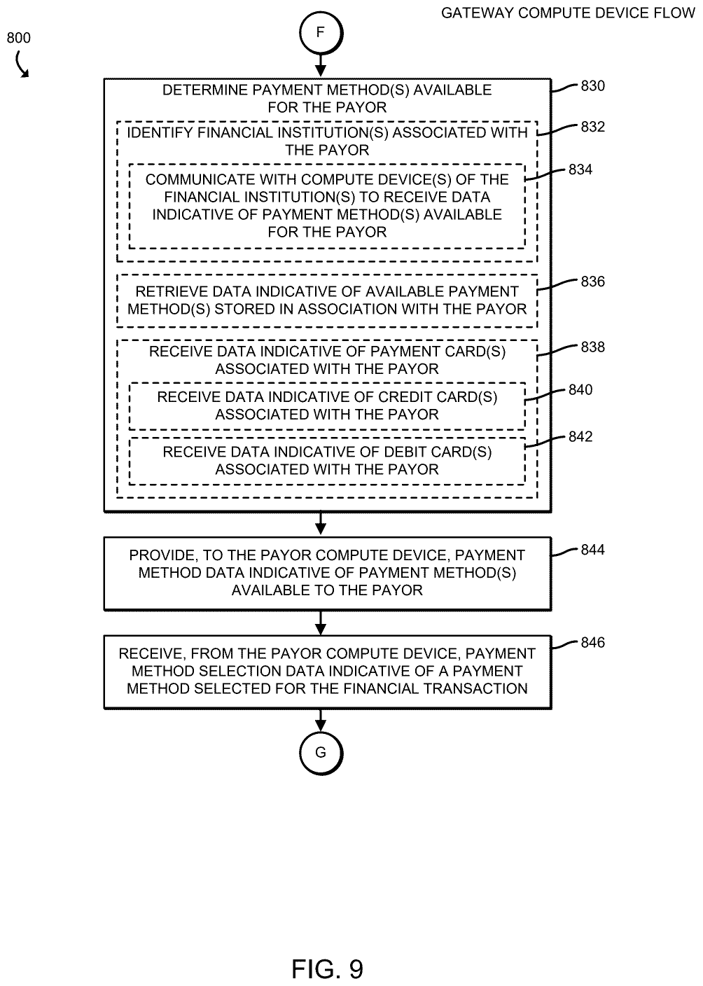

Referring now to FIG. 9, the method 800, in the illustrative embodiment, continues with block 830, in which the gateway compute device 130 determines a set of payment methods that are available for the payor to use for the financial transaction. In doing so, the gateway compute device 130 may identify one or more financial institutions (e.g., banks) that are associated with (e.g., have one or more financial accounts with) the payor (e.g., as indicated in a corresponding dataset (e.g., in the data storage 222)), as indicated in block 832. The gateway compute device 130 may communicate with compute devices 140, 142, 144 of the financial institutions to receive data indicative of payment methods available for the payor, as indicated in block 834. The gateway compute device 130, in some embodiments, may retrieve data (e.g., from data storage 222) indicative of available payment methods stored in association with the payor (e.g., based on previous communication with the compute devices 140, 142, 144 of the financial institutions for that information), as indicated in block 836. In the illustrative embodiment, the gateway compute device 130 may receive data indicative of one or more payment cards associated with the payor, as indicated in block 838. That is, in some embodiments, the gateway compute device 130 may receive data indicative of one or more credit cards associated with the payor and/or one or more debit cards associated with the payor, as indicated in blocks 840 and 842.

In block 844, in the illustrative embodiment, the gateway compute device 130 may provide, to the payor compute device 120 (e.g., through the network 160), payment method data which may embodied as any data indicative of the payment method(s) available to the payor (e.g., based on the payment methods determined in block 830). In block 846, the gateway compute device 130 may receive, from the payor compute device 120, payment method selection data indicative of a payment method selected for the financial transaction (e.g., the payment method selection data sent by the payor compute device 120 in block 364 of the method 300).

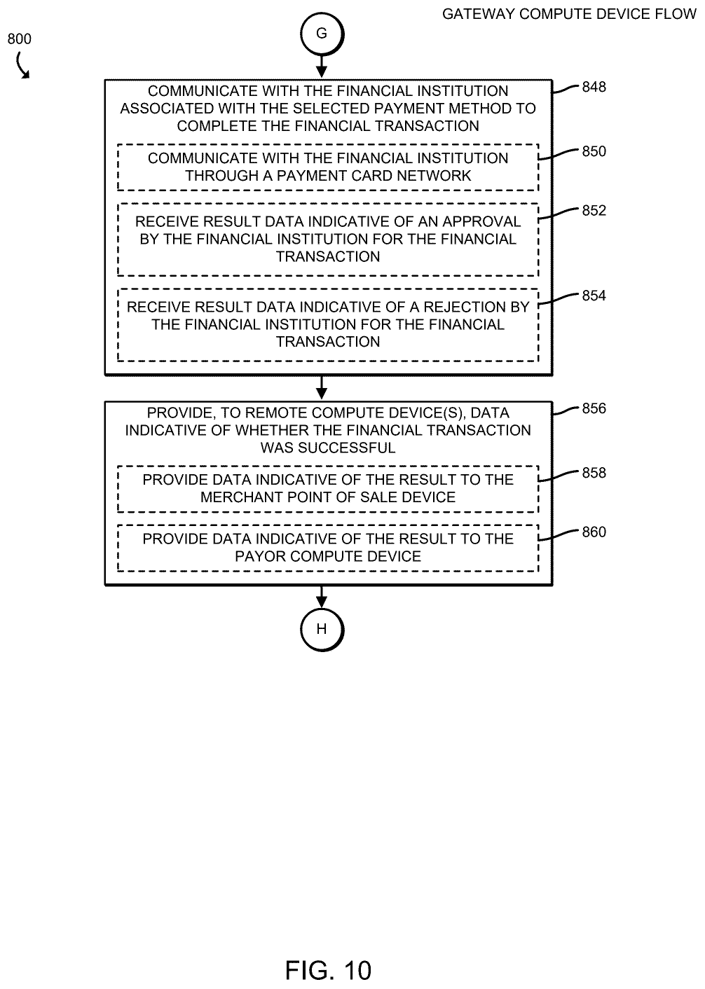

Referring now to FIG. 10, the gateway compute device 130 may communicate with the financial institution (e.g., the compute devices 140, 142, 144 of the corresponding financial institution) associated with the selected payment method to complete the financial transaction, as indicated in block 848. In doing so, and as indicated in block 850, the gateway compute device 130 may communicate with the financial institution through a payment network (e.g., one or more of the payment network compute devices 150, 152, which may be associated with the Visa, MasterCard, American Express, Discover, or other payment processing networks). Further, the gateway compute device 130 may receive result data indicative of an approval or a rejection by the corresponding financial institution for the financial transaction, as indicated in blocks 852 and 854. In block 856, the gateway compute device 130 may provide, to one or more remote compute devices, data indicative of whether the financial transaction was successful. In doing so, the gateway compute device 130 may provide data indicative of the result to the merchant point of sale device 110, as indicated in block 858 and/or to the payor compute device 120, as indicated in block 860. The gateway compute device 130 may provide the data indicative of the result via a persistent connection, long timeout HTTP connection, or WebSocket connection established with the gateway compute device 130 (e.g., between the gateway compute device 130 and the merchant point of sale device 110) earlier in the process (e.g., in block 802).

Though the operations of the methods 300, 600, 800 are described in a particular sequence, it should be understood that in other embodiments, operations may be performed in a different order and/or in parallel. While certain illustrative embodiments have been described in detail in the drawings and the foregoing description, such an illustration and description is to be considered as exemplary and not restrictive in character, it being understood that only illustrative embodiments have been shown and described and that all changes and modifications that come within the spirit of the disclosure are desired to be protected. There exist a plurality of advantages of the present disclosure arising from the various features of the apparatus, systems, and methods described herein. It will be noted that alternative embodiments of the apparatus, systems, and methods of the present disclosure may not include all of the features described, yet still benefit from at least some of the advantages of such features. Those of ordinary skill in the art may readily devise their own implementations of the apparatus, systems, and methods that incorporate one or more of the features of the present disclosure.

### EXAMPLES

Illustrative examples of the technologies disclosed herein are provided below. An embodiment of the technologies may include any one or more, and any combination of, the examples described below.

Example 1 includes a compute device comprising circuitry configured to obtain, at a merchant location, a notification transmitted from a merchant point of sale device, to facilitate a financial transaction, wherein the notification is indicative of a financial transaction that was initiated between the merchant point of sale device that is at the merchant location and a remote gateway compute device that is not at the merchant location; send, to the remote gateway compute device, payor identification data that identifies the payor associated with the financial transaction; and send, to the remote gateway compute device, payment method selection data indicative of a payment method selected by the payor for the financial transaction.

Example 2 includes the subject matter of Example 1, and wherein to obtain the notification comprises to obtain the notification as a visual code.

Example 3 includes the subject matter of any of Examples 1 and 2, and wherein to obtain the notification as a visual code comprises to obtain the notification as a two-dimensional matrix barcode.

Example 4 includes the subject matter of any of Examples 1-3, and wherein to obtain the notification comprises to obtain the notification through a short range wireless transmission.

Example 5 includes the subject matter of any of Examples 1-4, and wherein to obtain the notification through a short range wireless transmission comprises to obtain the notification through near-field communication.

Example 6 includes the subject matter of any of Examples 1-5, and wherein to obtain a notification comprises to obtain a notification that includes a transaction identifier that identifies the financial transaction that was initiated between the merchant point of sale device and the remote gateway compute device.

Example 7 includes the subject matter of any of Examples 1-6, and wherein to obtain a notification comprises to obtain a notification that includes an identifier of the merchant.

Example 8 includes the subject matter of any of Examples 1-7, and wherein to obtain a notification comprises to obtain a notification that additionally identifies a monetary amount for the financial transaction.

Example 9 includes the subject matter of any of Examples 1-8, and wherein the circuitry is further configured to receive an identity verification code from the remote gateway device; and send the identity verification code to the remote gateway device.

Example 10 includes the subject matter of any of Examples 1-9, and wherein circuitry is further configured to present a user interface indicative of one or more available payment methods associated with one or more financial institutions that the payor has one or more financial accounts with; and receive a user selection of a payment method from the one or more available payment methods.

Example 11 includes the subject matter of any of Examples 1-10, and wherein to present a user interface of indicative of one or more available payment methods comprises to present a user interface that lists one or more payment methods identified by the remote gateway compute device as being associated with one or more financial institutions that the payor has one or more financial accounts with.

Example 12 includes the subject matter of any of Examples 1-11, and wherein to present a user interface indicative of one or more available payment methods comprises to present a user interface that lists one or more credit cards or debit cards.

Example 13 includes the subject matter of any of Examples 1-12, and wherein the circuitry is further configured to present a prompt requesting the payor identification data from the payor.

Example 14 includes the subject matter of any of Examples 1-13, and wherein to send the payor identification data comprises to send an email address associated with the payor to the remote gateway compute device.

Example 15 includes the subject matter of any of Examples 1-14, and wherein the circuitry is further configured to receive result data indicative of whether the financial transaction was successful.

Example 16 includes a method comprising obtaining, by a compute device at a merchant location, a notification transmitted from a merchant point of sale device, to facilitate a financial transaction, wherein the notification is indicative of a financial transaction that was initiated between the merchant point of sale device that is at the merchant location and a remote gateway compute device that is not at the merchant location; sending, by the compute device and to the remote gateway compute device, payor identification data that identifies the payor associated with the financial transaction; and sending, by the compute device and to the remote gateway compute device, payment method selection data indicative of a payment method selected by the payor for the financial transaction.

Example 17 includes the subject matter of Example 16, and wherein obtaining a notification comprises obtaining the notification as a visual code.

Example 18 includes the subject matter of any of Examples 16 and 17, and wherein obtaining the notification as a visual code comprises obtaining the notification as a two-dimensional matrix barcode.

Example 19 includes the subject matter of any of Examples 16-18, and wherein obtaining a notification comprises obtaining the notification through a short range wireless transmission.

Example 20 includes the subject matter of any of Examples 16-19, and wherein obtaining the notification through a short range wireless transmission comprises obtaining the notification through near-field communication.

Example 21 includes the subject matter of any of Examples 16-20, and wherein obtaining a notification comprises obtaining a notification that includes a transaction identifier that identifies the financial transaction that was initiated between the merchant point of sale device and the remote gateway compute device.

Example 22 includes the subject matter of any of Examples 16-21, and wherein obtaining a notification comprises obtaining a notification that includes an identifier of the merchant.

Example 23 includes the subject matter of any of Examples 16-22, and wherein obtaining a notification comprises obtaining a notification that additionally identifies a monetary amount for the financial transaction.

Example 24 includes the subject matter of any of Examples 16-23, and further including receiving, by the compute device, an identity verification code from the remote gateway device; and sending, by the compute device, the identity verification code to the remote gateway device.

Example 25 includes the subject matter of any of Examples 16-24, and further including presenting, by the compute device, a user interface indicative of one or more available payment methods associated with one or more financial institutions that the payor has one or more financial accounts with; and receiving, by the compute device, a user selection of a payment method from the one or more available payment methods.

Example 26 includes the subject matter of any of Examples 16-25, and wherein presenting a user interface of indicative of one or more available payment methods comprises presenting a user interface that lists one or more payment methods identified by the remote gateway compute device as being associated with one or more financial institutions that the payor has one or more financial accounts with.

Example 27 includes the subject matter of any of Examples 16-26, and wherein presenting a user interface indicative of one or more available payment methods comprises presenting a user interface that lists one or more credit cards or debit cards.

Example 28 includes the subject matter of any of Examples 16-27, and further including presenting, by the compute device, a prompt requesting the payor identification data from the payor.

Example 29 includes the subject matter of any of Examples 16-28, and wherein sending the payor identification data comprises sending an email address associated with the payor to the remote gateway compute device.

Example 30 includes the subject matter of any of Examples 16-29, and further including receiving, by the compute device, result data indicative of whether the financial transaction was successful.

Example 31 includes one or more machine-readable storage media comprising a plurality of instructions stored thereon that, in response to being executed, cause a compute device to perform the methods of any of Examples 16-30.

Example 32 includes a compute device comprising circuitry configured to send, from a merchant location, a request to a remote gateway compute device to initiate a financial transaction, wherein the remote gateway compute device is not a the merchant location; receive, from the remote gateway compute device, a transaction identifier that identifies the financial transaction; provide, to a payor compute device at the merchant location, a notification that includes the transaction identifier to continue the financial transaction between the payor compute device and the remote gateway compute device; and receive, from the remote gateway compute device, result data indicative of whether the financial transaction was successful.

Example 33 includes the subject matter of Example 32, and wherein to provide the notification comprises to provide the notification through a short range wireless transmission to the payor compute device.

Example 34 includes the subject matter of any of Examples 32 and 33, and wherein to provide the notification through a short range wireless transmission comprises to provide the notification through near-field communication.

Example 35 includes the subject matter of any of Examples 32-34, and wherein to provide the notification comprises to provide the notification by displaying a visual code to the payor compute device.

Example 36 includes the subject matter of any of Examples 32-35, and wherein to provide the notification by displaying a visual code to the payor compute device comprises to provide the notification by displaying a two-dimensional matrix barcode.

Example 37 includes the subject matter of any of Examples 32-36, and wherein to send a request to the remote gateway compute device to initiate the financial transaction comprises to send a request that includes a merchant identifier.

Example 38 includes the subject matter of any of Examples 32-37, and wherein to send a request to the remote gateway compute device comprises to send a request that additionally includes data indicative of a monetary amount for the financial transaction.

Example 39 includes the subject matter of any of Examples 32-38, and wherein the circuitry is further configured to present, at the merchant location, a user interface that indicates an availability of a payment method associated with utilizing the remote gateway compute device to process a card not present transaction; and receive input data indicative of a selection to utilize the remote gateway compute device to process the card not present transaction; and wherein to send the request to the remote gateway compute device to initiate the financial transaction comprises to send the request in response to receipt of the input data indicative of the selection to utilize the remote gateway compute device to process the card not present transaction.

Example 40 includes the subject matter of any of Examples 32-39, and wherein to provide the notification to the payor compute device comprises to provide a notification that includes a merchant identifier.

Example 41 includes the subject matter of any of Examples 32-40, and wherein to provide the notification to the payor compute device comprises to provide a notification that additionally identifies a monetary amount for the financial transaction.

Example 42 includes the subject matter of any of Examples 32-41, and wherein the circuitry is further configured to provide, to the merchant point of sale device, data indicative of whether the financial transaction was successful.

Example 43 includes the subject matter of any of Examples 32-42, and wherein the circuitry is further configured to provide, to the payor compute device, data indicative of whether the financial transaction was successful.

Example 44 includes a method comprising sending, by a compute device at a merchant location, a request to a remote gateway compute device to initiate a financial transaction, wherein the remote gateway compute device is not a the merchant location; receiving, by the compute device and from the remote gateway compute device, a transaction identifier that identifies the financial transaction; providing, by the compute device and to a payor compute device at the merchant location, a notification that includes the transaction identifier to continue the financial transaction between the payor compute device and the remote gateway compute device; and receiving, by the compute device and from the remote gateway compute device, result data indicative of whether the financial transaction was successful.

Example 45 includes the subject matter of Example 44, and wherein providing the notification comprises providing the notification through a short range wireless transmission to the payor compute device.

Example 46 includes the subject matter of any of Examples 44 and 45, and wherein providing the notification through a short range wireless transmission comprises providing the notification through near-field communication.

Example 47 includes the subject matter of any of Examples 44-46, and wherein providing the notification comprises providing the notification by displaying a visual code to the payor compute device.

Example 48 includes the subject matter of any of Examples 44-47, and wherein providing the notification by displaying a visual code to the payor compute device comprises providing the notification by displaying a two-dimensional matrix barcode.

Example 49 includes the subject matter of any of Examples 44-48, and wherein sending a request to the remote gateway compute device to initiate the financial transaction comprises sending a request that includes a merchant identifier.

Example 50 includes the subject matter of any of Examples 44-49, and wherein sending a request to the remote gateway compute device comprises sending a request that additionally includes data indicative of a monetary amount for the financial transaction.

Example 51 includes the subject matter of any of Examples 44-50, and further including presenting, by the compute device at the merchant location, a user interface that indicates an availability of a payment method associated with utilizing the remote gateway compute device to process a card not present transaction; and receiving, by the compute device, input data indicative of a selection to utilize the remote gateway compute device to process the card not present transaction; and wherein sending the request to the remote gateway compute device to initiate the financial transaction comprises sending the request in response to receipt of the input data indicative of the selection to utilize the remote gateway compute device to process the card not present transaction.

Example 52 includes the subject matter of any of Examples 44-51, and wherein providing the notification to the payor compute device comprises providing a notification that includes a merchant identifier.

Example 53 includes the subject matter of any of Examples 44-52, and wherein providing the notification to the payor compute device comprises providing a notification that additionally identifies a monetary amount for the financial transaction.

Example 54 includes the subject matter of any of Examples 44-53, and further comprising providing, by the compute device and to the merchant point of sale device, data indicative of whether the financial transaction was successful.

Example 55 includes the subject matter of any of Examples 44-54, and further including providing, by the compute device and to the payor compute device, data indicative of whether the financial transaction was successful.

Example 56 includes one or more machine-readable storage media comprising a plurality of instructions stored thereon that, in response to being executed, cause a compute device to perform the methods of any of Examples 44-55.

Example 57 includes a compute device comprising circuitry configured to receive, from a remote merchant point of sale device at a merchant location, a request to initiate a financial transaction between a merchant and a payor; provide, to the remote merchant point of sale device, a transaction identifier that identifies the financial transaction; receive, from a remote payor compute device at the merchant location, a request to continue the financial transaction that was initiated with the remote merchant point of sale device; and communicate with a financial institution associated with a selected payment method to complete the financial transaction.

Example 58 includes the subject matter of Example 57, and wherein the circuitry is further configured to provide, to the remote payor compute device, payment method data indicative of one or more payment methods available to the payor; and receive, from the remote payor compute device, payment method selection data indicative of a payment method selected for the financial transaction.

Example 59 includes the subject matter of any of Examples 57 and 58, and wherein to provide payment method data indicative of one or more payment methods comprises to provide payment method data indicative of one or more credit cards or debit cards associated with the payor.

Example 60 includes the subject matter of any of Examples 57-59, and wherein the circuitry is further configured to verify an identity of the payor; identify one or more financial institutions associated with the payor; and communicate with one or more compute devices associated with the one or more financial institutions to receive data indicative of payment methods available for the payor.

Example 61 includes the subject matter of any of Examples 57-60, and wherein the circuitry is further configured to verify an identity of the payor; and retrieve data indicative of available payment methods stored in association with the payor.

Example 62 includes the subject matter of any of Examples 57-61, and wherein to receive, from the remote payor compute device, a request to continue the financial transaction comprises to receive a request from the payor compute device that includes the transaction identifier that identifies the financial transaction that was initiated with the remote merchant point of sale device.

Example 63 includes the subject matter of any of Examples 57-62, and wherein to receive a request to initiate a financial transaction comprises to receive a request that includes a merchant identifier.

Example 64 includes the subject matter of any of Examples 57-63, and wherein to receive a request to initiate the financial transaction comprises to receive a request that additionally identifies a monetary amount for the financial transaction.

Example 65 includes the subject matter of any of Examples 57-64, and wherein the circuitry is further configured to verify an identity of the payor by obtaining, from the payor compute device, contact information for the payor, sending a verification code to the payor, and receiving the verification code from the payor compute device.

Example 66 includes the subject matter of any of Examples 57-65, and wherein to obtain contact information for the payor comprises to obtain, from the payor compute device, an email address of the payor and wherein to send a verification code to the payor comprises to send the verification code to a phone number associated with the payor.

Example 67 includes the subject matter of any of Examples 57-66, and wherein the circuitry is further configured to provide, to the merchant point of sale device, data indicative of whether the financial transaction was successful.

Example 68 includes the subject matter of any of Examples 57-67, and wherein the circuitry is further configured to provide, to the payor compute device, data indicative of whether the financial transaction was successful.

Example 69 includes a method comprising receiving, by a compute device and from a remote merchant point of sale device at a merchant location, a request to initiate a financial transaction between a merchant and a payor; providing, by the compute device and to the remote merchant point of sale device, a transaction identifier that identifies the financial transaction; receiving, by the compute device and from a remote payor compute device at the merchant location, a request to continue the financial transaction that was initiated with the remote merchant point of sale device; and communicating, by the compute device, with a financial institution associated with a selected payment method to complete the financial transaction.

Example 70 includes the subject matter of Example 69, and further including providing, by the compute device and to the remote payor compute device, payment method data indicative of one or more payment methods available to the payor; and receiving, by the compute device and from the remote payor compute device, payment method selection data indicative of a payment method selected for the financial transaction.

Example 71 includes the subject matter of any of Examples 69 and 70, and wherein providing payment method data indicative of one or more payment methods comprises providing payment method data indicative of one or more credit cards or debit cards associated with the payor.

Example 72 includes the subject matter of any of Examples 69-71, and further including verifying, by the compute device, an identity of the payor; identifying, by the compute device, one or more financial institutions associated with the payor; and communicating, by the compute device, with one or more compute devices associated with the one or more financial institutions to receive data indicative of payment methods available for the payor.

Example 73 includes the subject matter of any of Examples 69-72, and further including verifying, by the compute device, an identity of the payor; and retrieving, by the compute device, data indicative of available payment methods stored in association with the payor.

Example 74 includes the subject matter of any of Examples 69-73, and wherein receiving, from the remote payor compute device, a request to continue the financial transaction comprises receiving a request from the payor compute device that includes the transaction identifier that identifies the financial transaction that was initiated with the remote merchant point of sale device.

Example 75 includes the subject matter of any of Examples 69-74, and wherein receiving a request to initiate a financial transaction comprises receiving a request that includes a merchant identifier.

Example 76 includes the subject matter of any of Examples 69-75, and wherein receiving a request to initiate the financial transaction comprises receiving a request that additionally identifies a monetary amount for the financial transaction.

Example 77 includes the subject matter of any of Examples 69-76, and further including verifying, by the compute device, an identity of the payor by obtaining, from the payor compute device, contact information for the payor, sending a verification code to the payor, and receiving the verification code from the payor compute device.

Example 78 includes the subject matter of any of Examples 69-77, and wherein obtaining contact information for the payor comprises obtaining, from the payor compute device, an email address of the payor and wherein sending a verification code to the payor comprises sending the verification code to a phone number associated with the payor.

Example 79 includes the subject matter of any of Examples 69-78, and further including providing, by the compute device and to the merchant point of sale device, data indicative of whether the financial transaction was successful.

Example 80 includes the subject matter of any of Examples 69-79, and further including providing, by the compute device and to the payor compute device, data indicative of whether the financial transaction was successful.

Example 81 includes one or more machine-readable storage media comprising a plurality of instructions stored thereon that, in response to being executed, cause a compute device to perform the methods of any of Examples 69-80.

1. A compute device comprising:
circuitry configured to:
obtain, at a merchant location, a notification transmitted from a merchant point of sale device, to facilitate a financial transaction, wherein the notification is indicative of a financial transaction that was initiated between the merchant point of sale device that is at the merchant location and a remote gateway compute device that is not at the merchant location;
send, to the remote gateway compute device, payor identification data that identifies the payor associated with the financial transaction; and
send, to the remote gateway compute device, payment method selection data indicative of a payment method selected by the payor for the financial transaction.

2. The compute device of claim 1, wherein to obtain the notification comprises to obtain the notification as a visual code.

3. The compute device of claim 1, wherein to obtain the notification comprises to obtain, through a short range wireless transmission, a notification that includes a transaction identifier that identifies the financial transaction that was initiated between the merchant point of sale device and the remote gateway compute device, an identifier of the merchant, and a monetary amount for the financial transaction.

4. The compute device of claim 1, wherein the circuitry is further configured to:
receive an identity verification code from the remote gateway device; and
send the identity verification code to the remote gateway device.

5. The compute device of claim 4, wherein circuitry is further configured to:
present a user interface indicative of one or more available payment methods associated with one or more financial institutions that the payor has one or more financial accounts with; and
receive a user selection of a payment method from the one or more available payment methods.

6. The compute device of claim 5, wherein to present a user interface of indicative of one or more available payment methods comprises to present a user interface that lists one or more payment methods identified by the remote gateway compute device as being associated with one or more financial institutions that the payor has one or more financial accounts with.

7. The compute device of claim 6, wherein to present a user interface indicative of one or more available payment methods comprises to present a user interface that lists one or more credit cards or debit cards.

8. A compute device comprising:
circuitry configured to:
send, from a merchant location, a request to a remote gateway compute device to initiate a financial transaction, wherein the remote gateway compute device is not a the merchant location;
receive, from the remote gateway compute device, a transaction identifier that identifies the financial transaction;
provide, to a payor compute device at the merchant location, a notification that includes the transaction identifier to continue the financial transaction between the payor compute device and the remote gateway compute device; and
receive, from the remote gateway compute device, result data indicative of whether the financial transaction was successful.

9. The compute device of claim 8, wherein to send a request to the remote gateway compute device to initiate the financial transaction comprises to send a request that includes a merchant identifier.

10. The compute device of claim 9, wherein to send a request to the remote gateway compute device comprises to send a request that additionally includes data indicative of a monetary amount for the financial transaction.

11. The compute device of claim 8, wherein the circuitry is further configured to:
present, at the merchant location, a user interface that indicates an availability of a payment method associated with utilizing the remote gateway compute device to process a card not present transaction; and
receive input data indicative of a selection to utilize the remote gateway compute device to process the card not present transaction; and
wherein to send the request to the remote gateway compute device to initiate the financial transaction comprises to send the request in response to receipt of the input data indicative of the selection to utilize the remote gateway compute device to process the card not present transaction.

12. The compute device of claim 8, wherein to provide the notification to the payor compute device comprises to provide a notification that includes a merchant identifier.

13. The compute device of claim 12, wherein to provide the notification to the payor compute device comprises to provide a notification that additionally identifies a monetary amount for the financial transaction.

14. The compute device of claim 8, wherein the circuitry is further configured to provide, to the merchant point of sale device, data indicative of whether the financial transaction was successful.

15. The compute device of claim 14, wherein the circuitry is further configured to provide, to the payor compute device, data indicative of whether the financial transaction was successful.

16. A compute device comprising:
circuitry configured to:
receive, from a remote merchant point of sale device at a merchant location, a request to initiate a financial transaction between a merchant and a payor;
provide, to the remote merchant point of sale device, a transaction identifier that identifies the financial transaction;
receive, from a remote payor compute device at the merchant location, a request to continue the financial transaction that was initiated with the remote merchant point of sale device; and
communicate with a financial institution associated with a selected payment method to complete the financial transaction.

17. The compute device of claim 16, wherein the circuitry is further configured to:
provide, to the remote payor compute device, payment method data indicative of one or more payment methods available to the payor; and
receive, from the remote payor compute device, payment method selection data indicative of a payment method selected for the financial transaction.

18. The compute device of claim 17, wherein to provide payment method data indicative of one or more payment methods comprises to provide payment method data indicative of one or more credit cards or debit cards associated with the payor.

19. The compute device of claim 16, wherein the circuitry is further configured to:
verify an identity of the payor;
identify one or more financial institutions associated with the payor; and
communicate with one or more compute devices associated with the one or more financial institutions to receive data indicative of payment methods available for the payor.

20. The compute device of claim 16, wherein the circuitry is further configured to:
verify an identity of the payor; and
retrieve data indicative of available payment methods stored in association with the payor.

21. The compute device of claim 16, wherein to receive, from the remote payor compute device, a request to continue the financial transaction comprises to receive a request from the payor compute device that includes the transaction identifier that identifies the financial transaction that was initiated with the remote merchant point of sale device.

22. The compute device of claim 16, wherein to receive a request to initiate a financial transaction comprises to receive a request that includes a merchant identifier.

23. The compute device of claim 22, wherein to receive a request to initiate the financial transaction comprises to receive a request that additionally identifies a monetary amount for the financial transaction.

24. The compute device of claim 16, wherein the circuitry is further configured to verify an identity of the payor by obtaining, from the payor compute device, contact information for the payor, sending a verification code to the payor, and receiving the verification code from the payor compute device.

25. The compute device of claim 24, wherein to obtain contact information for the payor comprises to obtain, from the payor compute device, an email address of the payor and wherein to send a verification code to the payor comprises to send the verification code to a phone number associated with the payor.

26. The compute device of claim 16, wherein the circuitry is further configured to provide, to the merchant point of sale device, data indicative of whether the financial transaction was successful.

27. The compute device of claim 26, wherein the circuitry is further configured to provide, to the payor compute device, data indicative of whether the financial transaction was successful.
